(19) United States
(12) Patent Application Publication
(10) Pub. No.: US 2013/0239108 A1
(43) Pub. Date: Sep. 12, 2013

(54) HYPERVISOR MANAGEMENT SYSTEM AND METHOD

(71) Applicant: HON HAI PRECISION INDUSTRY CO., LTD., New Taipei (TW)

(72) Inventors: CHUNG-I LEE, New Taipei (TW); CHIU-HUA LU, New Taipei (TW); TSUNG-HSIN YEN, New Taipei (TW); CHIEN-CHIH LIN, New Taipei (TW)

(73) Assignee: HON HAI PRECISION INDUSTRY CO., LTD., New Taipei (TW)

(21) Appl. No.: 13/751,019

(22) Filed: Jan. 25, 2013

(30) Foreign Application Priority Data
Mar. 8, 2012 (CN) 201210059196.2

(51) Int. Cl. G06F 9/455

(52) U.S. Cl. CPC G06F 9/45533
USPC 718/1

(57) ABSTRACT

A hypervisor management system is applied in a control center. The control center is connected to a plurality of servers via a network. Each of the plurality of servers has a hypervisor and an agent module. The hypervisor management system records information in relation to each hypervisor detected by the agent modules, creates an object file to record information of each virtual machine (VM) created by the hypervisors, and displays icons of all created VMs on a user interface. When an operation command is sent to a selected VM, the system converts the operation command into a control command suitable for the hypervisor that created the selected VM, where the control command has a format that is identifiable to the hypervisor, and performs an operation on the selected VM according to the control command and an object file of the selected VM.

### BACKGROUND

1. Technical Field

Embodiments of the present disclosure relate to virtualization technology, and more particularly to a hypervisor management system and method.

2. Description of Related Art

A hypervisor is a virtual machine manager that creates and runs virtual machines. At present, management of different hypervisors provided by different vendors rely on different platforms. Therefore, an improved hypervisor management system and method is desired.

### BRIEF DESCRIPTION OF THE DRAWINGS

FIG. 1 is a block diagram of one embodiment of an application environment of a hypervisor management system.

FIG. 2 is a block diagram of one embodiment of function modules of the hypervisor management system shown in FIG. 1.

FIG. 3 is a flowchart of one embodiment of a hypervisor management method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

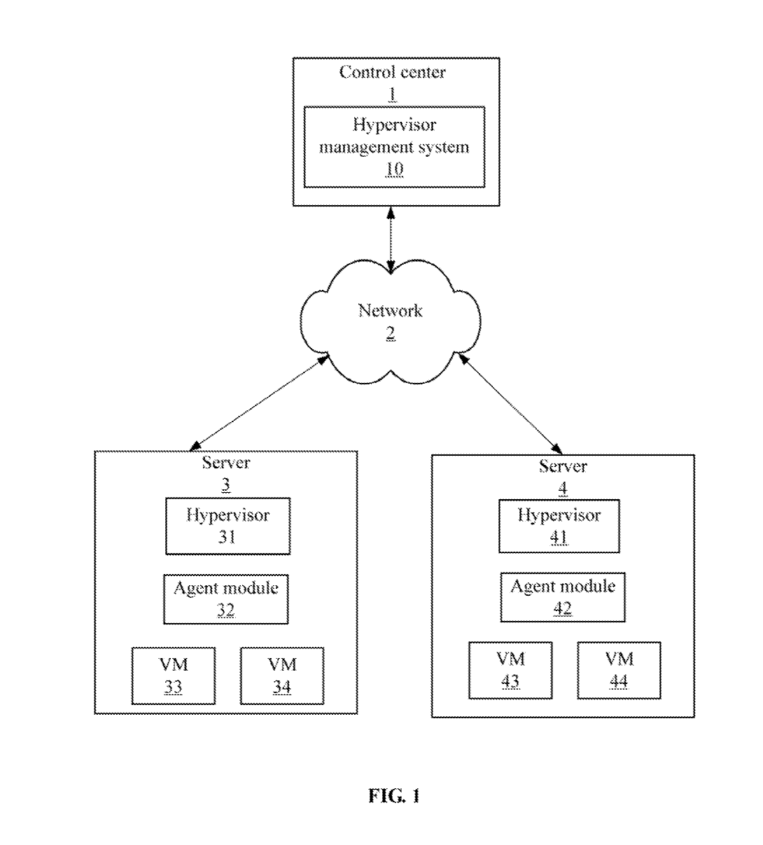

FIG. 1 is a block diagram of one embodiment of a hypervisor management system 10. The hypervisor management system 10 is applied in a control center 1. The control center is connected to a plurality of servers, such as a server 3 and a server 4, via a network 2. Each of the plurality of servers includes a hypervisor, an agent module, and one or more virtual machines (VMs) created by the hypervisor. For example, as shown in FIG. 1, the server 3 includes a hypervisor 31, an agent module 32, and one or more VMs (such as a VM 33 and a VM 34) created by the hypervisor 31. The server 4 includes a hypervisor 41, an agent module 42, and one or more VMs (such as a VM 43 and a VM 44) created by the hypervisor 41. In this embodiment, the hypervisors 31 and 41 are different types of hypervisors provided by different vendors. Types of the hypervisor may include vSphere, Citrix XenServer, PowerVM, KVM, Xen, VirtualBSD, for example. The control center 1 may be a computer or a server.

The agent module of each server detects information in relation to the hypervisor installed in the server, such as a type of the hypervisor and hardware specification (such as CPU, memory and hard disk resource information) of the hypervisor, and transmits the detected information to the hypervisor management system 10 via the network 2. Furthermore, when the hypervisor creates a VM, the agent module transmits information in relation to the created VM, such as CPU, memory and hard disk resources allocated to the created VM by the hypervisor, to the hypervisor management system 10 via the network 2.

The hypervisor management system 10 records the information in relation to all of the hypervisors installed in all the servers that are connected to the control center 1, and creates an object file for each created VM to record the information in relation to the created VM. When the control center 1 initiates an operation command on a selected VM, the hypervisor management system 10 converts the operation command into a control command according to the type of the hypervisor that created the selected VM, where the control command has a format that is identifiable to the hypervisor. Then, the hypervisor management system 10 performs one or more operations on the selected VM by sending the control command to the selected VM. The operations may include powering on the selected VM, powering off the selected VM, deleting the selected VM, amending configuration of the selected VM, and migrating the selected VM to another hypervisor.

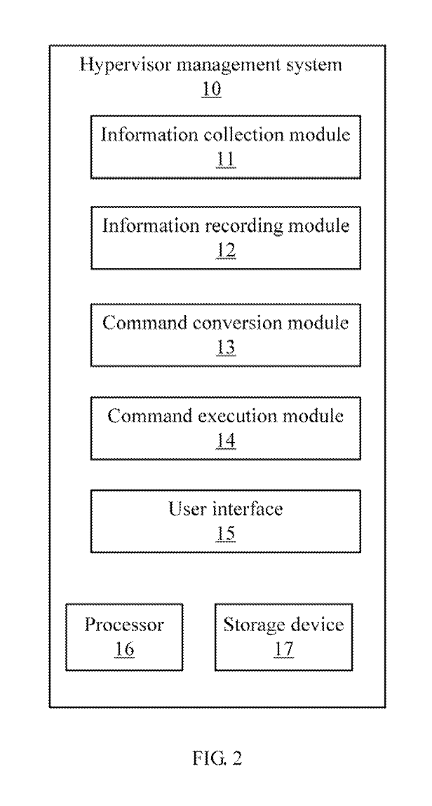

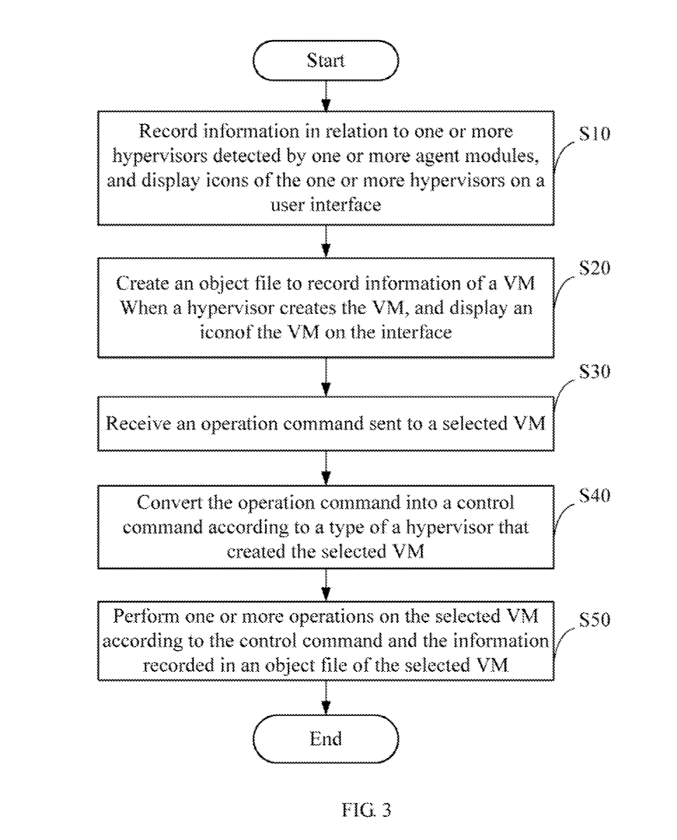

FIG. 2 is a block diagram of one embodiment of function modules of the hypervisor management system 10. The hypervisor management system 10 includes an information collection module 11, an information recording module 12, a command conversion module 13, a command execution module 14, a user interface 15, at least one processor 16, and a storage device 17. The user interface 15 displays icons of the hypervisors and the VMs, and the information in relation to the hypervisors and the VMs on a display device (not shown) of the control center. The modules 11-14 include computerized code in the form of one or more programs (computer-readable program code) that are stored in the storage device 17. The computerized code includes instructions that are executed by the at least one processor 16, to provide the functions of the hypervisor management system 10 as described above. The storage device 17 is a dedicated storage medium, such as an EPROM, a hard disk driver (HDD), or a flash memory. A description of functions of the modules 11-14 is given below and with reference to FIG. 3.

FIG. 3 is a flowchart of one embodiment of a hypervisor management method.

Depending on the embodiment, additional steps may be added, others removed, and the ordering of the steps may be changed.

In step S10, the information collection module 11 records information in relation to one or more hypervisors detected by one or more agent modules installed in the servers connected to the control center 1 via the network 2, and displays icons of the one or more hypervisors on the user interface 15 that is displayed on a display device. For example, the information collection module 11 receives and records information in relation to the hypervisor 31 detected by the agent module 32, and receives and records information in relation to the hypervisor 41 detected by the agent module 42. As mentioned above, the information in relation to each hypervisor includes a type of the hypervisor and hardware specification (such as CPU, memory and hard disk resource information) of the hypervisor. The information in relation to the one or more hypervisors may also be displayed on the user interface.

In step S20, when receiving a notice from an agent module that informs a hypervisor has created a VM, the information recording module 12 creates an object file for the created VM, and records information in relation to the created VM in the object file. The information in relation to the created VM includes CPU, memory and hard disk allocated to the created VM by the hypervisor. For example, when the hypervisor 31 creates the VM 33, the agent module 32 sends a notice to the hypervisor management system 10 of the information in relation to the VM 33. The information recording module 12 creates an object file, records the information in relation to the VM 33 in the object file, and displays an icon of the VM 33 on the user interface.

The information in relation to the VM 33 may also be displayed on the user interface.

In step S30, the command conversion module 13 receives an operation command sent to a selected VM that is displayed on the user interface 15. For example, a manager of the control center 1 may select the icon of the VM 33 displayed on the user interface 15 and initiate the operation command The operation command may be a power-on command (such as “Power on VM 33”), or a power-off command (such as “Power off VM 33”), for example.

In step S40, the command conversion module 13 converts the operation command into a control command according to a type of a hypervisor that created the selected VM, where the control command has a format that is identifiable to the hypervisor. For example, the hypervisor 31 that created the VM 33 may be a KVM type, and the hypervisor 41 that created the VM 43 may be a Xen type. When the operation command is “Power off VM 33,” the conversion module 13 may convert the operation command into a control command with a format of “H31 (kvm) virsh shutdown vm33” which is appropriate for the KVM system. When the operation command is “Power off VM 43,” the conversion module 13 may convert the operation command into a control command with a format of “H41 (xen) xm shutdown vm43” which is appropriate for the Xen system.

In step S50, the command execution module 14 performs one or more operations on the selected VM according to the control command and the information recorded in an object file of the selected VM. For example, if the control command is to power on the VM 33, the command execution module powers on the VM 33. If the control command is to delete the

VM 33, the command execution module deletes the VM 33 and the object file of the VM 33 from the server 3. If the control command is to migrate the VM 33 from the server 3 to the server 4, the command execution module copies a memory image and the object file of the VM 33 from the server 3 to the server 4, and allocates corresponding CPU, memory and hard disk resources of the server 4 to the VM 33 according to the object file of the VM 33. The memory image of a VM includes executable files in relation to the VM that is stored in memory space of the VM.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A hypervisor management method being executed by a processor of a control center, the control center being connected with a plurality of servers via a network, each of the plurality of server is installed with a hypervisor, the method comprising:
recording information in relation to each hypervisor detected by an agent module installed in each server connected to the control center, and displaying an icon of the hypervisor on a user interface that is displayed on a display device;
when receiving a notice that informs a hypervisor has created a VM sent by an agent module, creating an object file for the created VM, recording information in relation to the created VM in the object file, and displaying an icon of the created VM on the user interface;
receiving an operation command sent to a selected VM that is displayed on the user interface;
converting the operation command into a control command according to a type of a hypervisor that created the selected VM, wherein the control command has a format that is identifiable to the hypervisor; and
performing one or more operations on the selected VM according to the control command and the information recorded in an object file of the selected VM.

2. The method of claim 1, wherein the information in relation to each hypervisor comprises the type of the hypervisor and hardware specification of the hypervisor.

3. The method of claim 1, wherein the information in relation to the selected VM comprises CPU, memory, and hard disk resources that are allocated to the selected VM by the hypervisor that created the selected VM.

4. The method of claim 1, further comprising: displaying the information in relation to each hypervisor on the user interface.

5. The method of claim 1, further comprising: displaying the information in relation to each created VM on the user interface.

6. The method of claim 1, wherein the one or more operations comprise powering on the selected VM, powering off the selected VM, deleting the selected VM, and migrating the selected VM from the hypervisor that created the selected VM to another hypervisor.

7. A hypervisor management system being connected with a plurality of servers via a network, each of the plurality of server is installed with a hypervisor, the system comprising:
at least one processor;
a storage device having computer code stored thereon that, when executed by the at least one processor, causes the at least one processor to perform operations of:
recording information in relation to each hypervisor detected by an agent module installed in each server connected to the system, and displaying an icon of the hypervisor on a user interface that is displayed on a display device;
when receiving a notice that informs a hypervisor has created a VM sent by an agent module, creating an object file for the created VM, recording information in relation to the created VM in the object file, and displaying an icon of the created VM on the user interface;
receiving an operation command sent to a selected VM that is displayed on the user interface;
converting the operation command into a control command according to a type of a hypervisor that created the selected VM, wherein the control command has a format that is identifiable to the hypervisor; and
performing one or more operations on the selected VM according to the control command and the information recorded in an object file of the selected VM.

8. The system of claim 7, wherein the information in relation to each hypervisor comprises the type of the hypervisor and hardware specification of the hypervisor.

9. The system of claim 7, wherein the information in relation to the selected VM comprises CPU, memory, and hard disk resources that are allocated to the selected VM by the hypervisor that created the selected VM.

10. The system of claim 7, wherein the operations performed by the at least one processor further comprise: displaying the information in relation to each hypervisor on the user interface.

11. The system of claim 7, wherein the operations performed by the at least one processor further comprise: displaying the information in relation to each created VM on the user interface.

12. The method of claim 1, wherein the one or more operations performed on the selected VM comprise powering on the selected VM, powering off the selected VM, deleting the selected VM, and migrating the selected VM from the hypervisor that created the selected VM to another hypervisor.

13. A non-transitory computer-readable medium having stored thereon instructions that, when executed by a processor of a control center that is connected with a plurality of servers via a network, causing the processor to perform a method for managing hypervisors installed in the servers, the method comprising:
recording information in relation to each hypervisor detected by an agent module installed in each server connected to the control center, and displaying an icon of the hypervisor on a user interface that is displayed on a display device;
when receiving a notice that informs a hypervisor has created a VM sent by an agent module, creating an object file for the created VM, recording information in relation to the created VM in the object file, and displaying an icon of the created VM on the user interface;
receiving an operation command sent to a selected VM that is displayed on the user interface;
converting the operation command into a control command according to a type of a hypervisor that created the selected VM, wherein the control command has a format that is identifiable to the hypervisor; and
performing one or more operations on the selected VM according to the control command and the information recorded in an object file of the selected VM.

14. The medium of claim 13, wherein the information in relation to each hypervisor comprises the type of the hypervisor and hardware specification of the hypervisor.

15. The medium of claim 13, wherein the information in relation to the selected VM comprises CPU, memory, and hard disk resources that are allocated to the selected VM by the hypervisor that created the selected VM.

16. The medium of claim 13, wherein the method further comprises: displaying the information in relation to each hypervisor on the user interface.

17. The medium of claim 13, wherein the method further comprises: displaying the information in relation to each created VM on the user interface.

18. The medium of claim 13, wherein the method further comprises, wherein the one or more operations comprise powering on the selected VM, powering off the selected VM, deleting the selected VM, and migrating the selected VM from the hypervisor that created the selected VM to another hypervisor.
